(19) United States
(12) Patent Application Publication
(10) Pub. No.: US 2009/0172685 A1
(43) Pub. Date: Jul. 2, 2009

(54) SYSTEM AND METHOD FOR IMPROVED SCHEDULING OF CONTENT TRANSCODING

(75) Inventor: Eyal Shavit, Palo Alto, CA (US)

Correspondence Address: MURABITO, HAO & BARNES, LLP, TWO NORTH MARKET STREET, THIRD FLOOR, SAN JOSE, CA, 95113, US

(73) Assignee: MEVIO INC., San Francisco, CA (US)

(21) Appl. No.: 12/243,831

(22) Filed: Oct. 1, 2008

Related U.S. Application Data
(60) Provisional application No. 60/997,262, filed on Oct. 1, 2007.

(51) Int. Cl. G06F 9/46

(52) U.S. Cl. 718/103

(57) ABSTRACT

A method and system for improved scheduling of content transcoding is disclosed. Embodiments are capable of generating and assigning a first transcoding priority value to a piece of content, where the first transcoding priority value is based upon information about the content and at least one semi-static constraint. A second transcoding priority value may also be generated and assigned based upon the first transcoding priority value and at least one dynamic constraint. Transcoding of the content may be scheduled using the first and/or second transcoding priority values, thereby providing scheduling of content transcoding which takes into account longer-term knowledge and/or shorter-term knowledge for better assessment of the demand for transcoding of a given piece of content. Accordingly, embodiments enable transcoding of content with reduced resource load, reduced transcoding cost, and improved quality of service.

### RELATED APPLICATIONS

The present application is related to and claims the benefit of U.S. Provisional Patent Application No. 60/997,262, filed Oct. 1, 2007, entitled “PREDICTIVE TRANSCODING,” naming Eyal Shavit as the inventor, assigned to the assignee of the present invention, and having attorney docket number PODS-P001.PRO. That application is incorporated herein by reference in its entirety and for all purposes.

### BACKGROUND OF THE INVENTION

Transcoding of content has become much more important as the amount of content and the number of means for accessing the content has increased. For example, the price of hardware and software for creating videos continues to drop, thereby making it more affordable and easier for people to upload and share their content with anyone in the world using personal content websites such as Youtube.com. Additionally, an increasing number of devices, both portable and non-portable, are capable of accessing and playing the content, where each device may require the content in a different form (e.g., with a specific format, resolution, frame rate, etc.). Accordingly, the number of transcodings is continually increasing to accommodate the increasing amount of content and the increasing number of device types and content forms.

As the demand for content transcoding increases, scheduling of the transcoding becomes more of an issue as conventional transcoding systems are less able to keep up with the demand. For example, conventional first-in-time transcoding systems transcode content in the order in which transcoding requests are received. If all the transcoding resources of such a system are currently in use, then subsequent requests are queued and not processed until the previously-requested transcodings are completed. This is especially problematic where the queued content is in higher demand and is of a smaller file size than the content being transcoded. Thus, the ability of most conventional transcoding systems to accurately assess the demand for a given piece of content is limited, and therefore, most conventional transcoding systems operate with high resource load, high transcoding cost, and low quality of service as the mean wait time for content is relatively high. These disadvantages equate to a poor user experience, and this worsens as the library of available content on a website increases.

Additionally, most conventional transcoding systems do not consider business relationships when scheduling the transcoding of content. For example, the queued content may be associated with an advertiser or other client which has paid for the distribution of the queued content, whereas other content currently being transcoded is not. In this case, transcoding of paid content is being delayed at the expense of transcoding non-paid content. As such, the use of conventional transcoding systems may result in loss of business, failure to honor business relationships, and the like. Further, most conventional transcoding systems are unable to handle unexpected events or otherwise make last-minute changes to the transcoding schedule once the content is scheduled for transcoding, thereby further increasing transcoding cost and decreasing quality of service.

### SUMMARY OF THE INVENTION

Accordingly, a need exists for more accurate assessment of the demand for a given piece of content to be transcoded. A need also exists for scheduling of content transcoding such that resource load on the transcoding system is reduced. Additionally, a need exists for scheduling of content transcoding such that transcoding cost is reduced. A need also exists for scheduling of content transcoding such that quality of service is improved. Further, a need exists for scheduling of content transcoding which takes into account business relationships and other conditions. A need also exists for scheduling of content transcoding which is able to handle unexpected events and make last-minute changes to the transcoding schedule. Further, a need exists for a more efficient transcoding system for various device types and forms of content. Embodiments of the present invention provide novel solutions to these needs and others as described below.

Embodiments are directed to a method and system for improved scheduling of content transcoding for improved content delivery. More specifically, embodiments are capable of generating and assigning a first transcoding priority value to a piece of content, where the first transcoding priority value is based upon information about the content (e.g., a file size, a playback duration, a file identifier, information about the content prior to transcoding, information about the content after transcoding, etc.) and at least one semi-static constraint (e.g., a business relationship constraint, a product marketing constraint, a consumption pattern constraint, a system performance constraint, etc). A second transcoding priority value may also be generated and assigned based upon the first transcoding priority value and at least one dynamic constraint (e.g., a business relationship constraint, a product marketing constraint, a consumption pattern constraint, a system performance constraint, a system error, a system exception, another system-generated constraint, a user-input constraint, etc). Transcoding of the content may be scheduled using the first and/or second transcoding priority values, thereby providing scheduling of content transcoding which takes into account longer-term knowledge (e.g., represented by semi-static constraints) and/or shorter-term knowledge (e.g., represented by dynamic constraints) for better assessment of the demand for transcoding of a given piece of content. Accordingly, embodiments enable transcoding of content with reduced resource load, reduced transcoding cost, and improved quality of service.

In one embodiment, a method of scheduling content transcoding includes accessing information (e.g., a file size, a playback duration, a file identifier, information about the content prior to the transcoding, information about the content after the transcoding, etc.) about the content to be transcoded. A semi-static constraint (e.g., a business relationship constraint, a product marketing constraint, a consumption pattern constraint, a system performance constraint, etc.) associated with transcoding of the content is accessed. A first transcoding priority value for the content is generated based upon the semi-static constraint and the information, wherein the first transcoding priority value is for use in scheduling transcoding of the content with respect to transcoding of other content. The method may also include scheduling the transcoding of the content based upon the first transcoding priority value. In one embodiment, the method may also include accessing a dynamic constraint (e.g., a business relationship constraint, a product marketing constraint, a consumption pattern constraint, a system performance constraint, a system error, a system exception, another system-generated constraint, a user-input constraint, etc.) associated with transcoding of the content. A second transcoding priority value may be generated for the content based upon the first transcoding priority value and the dynamic constraint, wherein the second transcoding priority value is for use in scheduling transcoding of the content with respect to transcoding of the other content. And in one embodiment, the method may also include scheduling the transcoding of the content based upon the second transcoding priority value. Once scheduled and transcoded (e.g., based upon the first transcoding priority value and/or the second transcoding priority value), the content may be delivered to a requester (e.g., user, content provider, one or more entities providing content via at least one channel, etc.), where the delivery may also include rendering the transcoded content for presentation (e.g., to the requester, another user, etc.) in one embodiment.

In another embodiment, a system for scheduling content transcoding may include a memory for storing a semi-static constraint associated with transcoding of content. A first component is coupled to the memory and operable to access information about the content to be transcoded, the first component further for generating a first transcoding priority value for the content based upon the semi-static constraint and the information, wherein the first transcoding priority value is for use in scheduling transcoding of the content with respect to transcoding of other content. The system may also include a scheduler for scheduling the transcoding of the content based upon the first transcoding priority value. In one embodiment, the system may also include a second component coupled to the first component and for accessing a dynamic constraint associated with transcoding of the content, the second component further for generating a second transcoding priority value for the content based upon the first transcoding priority value and the dynamic constraint, and wherein the second transcoding priority value is for use in scheduling transcoding of the content with respect to transcoding of the other content. And in one embodiment, the system may also include a scheduler for scheduling the transcoding of the content based upon the second transcoding priority value. Once scheduled and transcoded (e.g., based upon the first transcoding priority value and/or the second transcoding priority value), the content may be delivered to a requester (e.g., user, content provider, one or more entities providing content via at least one channel, etc.), where the delivery may also include rendering the transcoded content for presentation (e.g., to the requester, another user, etc.) in one embodiment.

In yet another embodiment, a system for transcoding content includes a memory for storing a semi-static constraint associated with transcoding of content. A first component is coupled to the memory and for accessing information about the content to be transcoded, the first component further for generating a first transcoding priority value for the content based upon the semi-static constraint and the information. A scheduler is coupled to the first component and for scheduling the transcoding of the content based upon the first transcoding priority value. A transcoder is coupled to the scheduler and for accessing and transcoding the content in accordance with the scheduling. The system may also include a second component coupled to the first component and for accessing a dynamic constraint associated with transcoding of the content, the second component further for generating a second transcoding priority value for the content based upon the first transcoding priority value and the dynamic constraint, and wherein the second transcoding priority value is for use in scheduling the transcoding of the content with respect to the transcoding of the other content. Additionally, in one embodiment, the scheduler may be further operable to schedule the transcoding of the content based upon the second transcoding priority value. Once scheduled and transcoded (e.g., based upon the first transcoding priority value and/or the second transcoding priority value), the content may be delivered to a requester (e.g., user, content provider, one or more entities providing content via at least one channel, etc.), where the delivery may also include rendering the transcoded content for presentation (e.g., to the requester, another user, etc.) in one embodiment.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary transcoding system in accordance with one embodiment of the present invention.

FIG. 2 shows an exemplary data flow diagram of priority value generation for use in scheduling of content transcoding in accordance with one embodiment of the present invention.

FIG. 3 shows a block diagram of the transcoding of content into multiple forms in accordance with one embodiment of the present invention.

FIG. 4 shows an exemplary process for scheduling content transcoding in accordance with one embodiment of the present invention.

FIG. 5 shows an exemplary process for delivering transcoded content to a content requester in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Notation and Nomenclature

Some regions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing the terms such as “aborting,” “accepting,” “accessing,” “adding,” “adjusting,” “analyzing,” “applying,” “assembling,” “assigning,” “balancing,” “blocking,” “calculating,” “capturing,” “combining,” “comparing,” “collecting,” “creating,” “debugging,” “defining,” “depicting,” “detecting,” “determining,” “displaying,” “establishing,” “executing,” “flipping,” “generating,” “grouping,” “hiding,” “identifying,” “initiating,” “interacting,” “modifying,” “monitoring,” “moving,” “outputting,” “performing,” “placing,” “presenting,” “processing,” “programming,” “querying,” “removing,” “repeating,” “resuming,” “sampling,” “simulating,” “sorting,” “storing,” “subtracting,” “suspending,” “tracking,” “transcoding,” “transforming,” “unblocking,” “using,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### EMBODIMENTS OF THE INVENTION

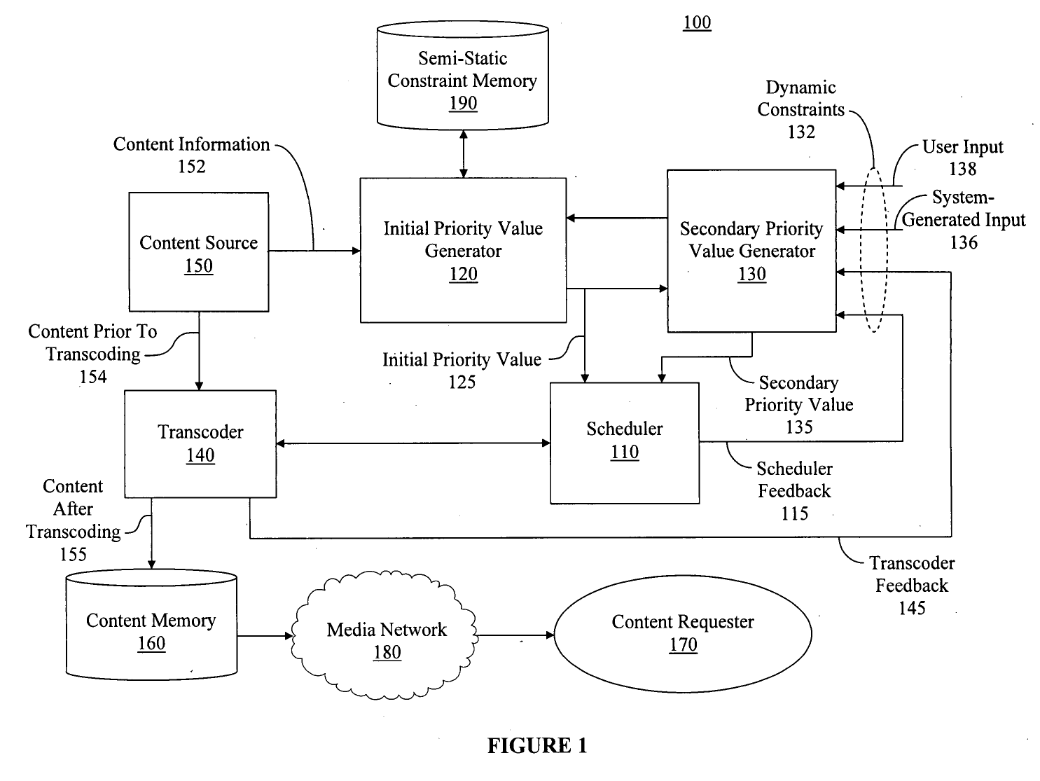

FIG. 1 shows exemplary transcoding system 100 in accordance with one embodiment of the present invention. As shown in FIG. 1, scheduler 110 can schedule transcoding of content using initial transcoding priority value 125 (e.g., generated by initial priority value generator 120) and/or secondary transcoding priority value 135 (e.g., generated by secondary priority value generator 130). In one embodiment, initial priority value 125 may be used to prioritize content for transcoding based upon longer-term knowledge (e.g., representing a “world model” comprising information which changes less over time such as business relationships, product marketing information, etc.), whereas secondary priority value 135 may be used to prioritize content for transcoding based upon shorter-term knowledge (e.g., unexpected events, information which changes more frequently, changes in content popularity, etc.). Transcoder 140 may access content from content source 150 and transcode the content in accordance with scheduling information generated by scheduler 110. After the content is transcoded by transcoder 140, the transcoded content may be stored in content memory 160 before distribution to content requester 170 via media network 180.

Initial priority value generator 120 may generate initial priority value 125 based upon information about the content to be transcoded (e.g., content information 152 accessed from content source 150) and at least one semi-static constraint (e.g., accessed from semi-static constraint memory 190). Content information 152 may comprise a file size, a playback duration, a file identifier (e.g., file name, file number, etc.), information about the content prior to transcoding (e.g., a video or data format, a resolution, a frame rate, etc. of content prior to transcoding 154), information about the content after transcoding (e.g., a video or data format, a resolution, a frame rate, etc. of content after transcoding 156), etc. The semi-static constraint may comprise information, knowledge, rules, etc. which change relatively infrequently and/or with a relatively small magnitude (e.g., a business relationship constraint, a product marketing constraint, a consumption pattern constraint, a system performance constraint, etc). Accordingly, the demand for transcoding of a given piece of content (e.g., identified by content information 152) may be assessed using knowledge in the form of a semi-static constraint (e.g., accessed from semi-static constraint memory 190), thereby enabling the content (e.g., 154) to be scheduled for transcoding (e.g., by accessing initial priority value 125 associated with the content) with respect to other pieces of content to reduce resource load on system 100, reduce transcoding cost associated with system 100, improve quality of service associated with system 100, or some combination thereof.

In one embodiment, the semi-static constraint accessed from semi-static constraint memory 190 may comprise a business relationship constraint, where the business relationship associated with the business relationship constraint may be comprise a relatively long-term business relationship (e.g., lasting one or more weeks, months, etc.). For example, if a business relationship exists between a content distributor and a content producer, then content generated by the content producer may be prioritized above other content which is associated with less-important content producers (e.g., which provide less revenue to content distributors, produce less content, etc.), other content which is not associated with an entity with which a business relationship exists, etc. Thus, the semi-static constraint may comprise a rule which states that content from the content producer is to be prioritized (e.g., during determination of a transcoding schedule for the different pieces of content) above content from other sources.

And as a further example, the content producer may make a request to the content distributor to promote or provide greater distribution/exposure for content A over content B, and therefore, content A may be prioritized above content B based upon this request. Accordingly, the semi-static constraint may comprise a rule which states that content A from the content producer is to be prioritized above content B from the content producer.

The semi-static constraint may also be associated with a business relationship between a content distributor and any other content partner. For example, a content partner (e.g., any business entity or person with a contractual or other business relationship with the content distributor) may have a business relationship with a content producer or otherwise be interested in promoting certain content. As such, a semi-static constraint may exist which specifies that the content associated with the business partner be prioritized above content from other sources in one embodiment.

In another embodiment, the semi-static constraint may be derived from a relationship between a content distributor and an advertiser. For example, if advertiser A provides 30% of the advertising revenue of the content distributor while advertiser B provides only 5% of the content distributor's advertising revenue, then content associated with advertiser A (e.g., videos or other content bundled with advertisements from advertiser A, content with product placement associated with advertiser A, etc.) may be prioritized above content associated with advertiser B.

Alternatively, the semi-static constraint accessed from semi-static constraint memory 190 may comprise a product marketing constraint. For example, a content distributor may bundle or package content for delivery via one or more channels for access by portable devices (e.g., mobile phones, personal digital assistants (PDAs), gaming devices, etc.), non-portable devices (e.g., computer servers, desktop computers, gaming consoles, etc.), etc. As such, the content distributor may want to promote or push a given channel (e.g., based upon the popularity of the channel, a language spoken in the majority of the content of the channel, etc.), and therefore, the semi-static constraint may comprise a rule which states that content to be delivered via channel A should be prioritized above content to be delivered via channel B.

In one embodiment, the semi-static constraint may comprise a consumption pattern constraint, where the constraint may be based upon a quantity of previous transcodings of a certain piece of content, a quantity of previous requests for transcoding of a certain piece of content, etc. For example, where content X has been transcoded more times than content Y, the semi-static constraint may comprise a rule which states that content X is to be prioritized above content Y. Additionally, where the requests for transcoding of content X exceed the requests for content Y, the semi-static constraint may comprise a rule which states that content X is to be prioritized above content Y. Further, where content X comprises a “viral video” for which a large number of requests are received in a relatively short amount of time, content X may be prioritized above other content in one embodiment.

Alternatively, the semi-static constraint accessed from semi-static constraint memory 190 may comprise a system performance constraint (e.g., associated with one or more components of system 100). For example, if system 100 is able to transcode content from format A to format B more quickly than from format A to format C, then transcodings from format A to format B may be prioritized above transcodings from format A to format C in one embodiment. Alternatively, the semi-static constraint may be associated with some other characteristic (e.g., number of transcoders, bandwidth of each transcoder, bandwidth of multiple transcoders operating in parallel, etc.) of transcoding system 100. The system performance constraint may also relate to the content being transcoded (e.g., content less than size X is to be prioritized above content of a size greater than Y) in one embodiment. And in another embodiment, the semi-static constraint may be associated with functional performance of the transcoding system (e.g., 100). For example, the semi-static constraint may comprise a rule which states: if the wait time for an end-user exceeds one minute when transcoding content X before content Y, then transcode content Y before content X.

Accordingly, as shown in FIG. 1, initial priority value generator 120 may generate initial priority value 125 (e.g., for scheduling content 154 for transcoding, for use in generating additional or updated priority values, etc.) based upon one or more semi-static constraints accessed from semi-static constraint memory 190. Content information 152 may be accessed for the content (e.g., accessed from content source 150) for which transcoding is requested and used by initial priority value generator 120 to generate initial priority value 125. For example, where content X (e.g., associated with advertiser X per content information 152), content Y (e.g., associated with advertiser Y per content information 152) and content Z (e.g., associated with advertiser Z per content information 152) are to be scheduled for transcoding, and at least one semi-static constraint is accessed which states that content associated with advertiser X is to be prioritized above content associated with advertiser Y and that content associated with advertiser Y is to be prioritized above content associated with advertiser Z, then the content may be assigned respective initial priority values (e.g., 125) which indicate the following scheduling order: 1) content X; 2) content Y; and 3) content Z. As a further example, where content information 152 indicates that content X is to be transcoded from format A to format B and that content Y is to be transcoded from format A to format C, and where at least one semi-static constraint is accessed which indicates that transcoding from format A to format B is quicker than transcoding from format A to format C, then the content may be assigned respective initial priority values (e.g., 125) which indicate the following scheduling order: 1) content X; and 2) content Y.

Initial priority value 125 may be accessed by scheduler 110 for scheduling transcoding of the content in one embodiment. Alternatively, initial priority value 125 may be accessed by secondary priority value generator 130 for use in generating secondary priority value 135. For example, secondary priority value generator 130 may access one or more dynamic constraints 132 and use dynamic constraints 132 to adjust the priority or scheduling order of content to be transcoded. It should be appreciated that content information 152 may be communicated to secondary priority value generator 130 via initial priority value generator 120 and/or directly to second priority value generator 130 from content source 150. Any change to the scheduling order may be indicated by the second priority value assigned to the respective pieces of content. Thereafter, scheduler 110 may access the respective second priority values (e.g., 135) for the content and use this information to schedule transcoding of the content.

Dynamic constraints 132 may comprise information, knowledge, rules, etc. which change more frequently and/or with a larger magnitude than semi-static constraints accessed from semi-static constraint memory 190. For example, dynamic constraints 132 may comprise a business relationship constraint (e.g., an unexpected change to an existing business relationship, an agreement to provide or promote content for a short time, beginning at a time close to the previously-scheduled transcoding, etc.), a product marketing constraint (e.g., an unexpected change associated with marketing of a product, a short-term product marketing constraint, etc.), a consumption pattern constraint (e.g., an unexpected change in consumption of content, a short-term consumption pattern constraint, etc.), a system performance constraint (e.g., an unexpected change in system performance or functionality, a short-term system performance constraint, etc.), some combination thereof, etc.

Dynamic constraints 132 may also comprise a system error (e.g., an error associated with one or more components of system 100) and/or a system exception (e.g., an exception associated with one or more components of system 100). For example, scheduler feedback 115 may indicate an error and/or exception related to the performance of scheduler 110 and may be used by secondary priority value generator 130 to generate a secondary priority value (e.g., 135) which may reflect or otherwise accommodate the scheduling error and/or scheduling exception (e.g., by dictating an updated or changed transcoding schedule for the content). Alternatively, transcoder feedback 145 may indicate an error and/or exception related to the performance of transcoder 140 and may be used by secondary priority value generator 130 to generate a secondary priority value (e.g., 135) which may reflect or otherwise accommodate the transcoding error and/or transcoding exception (e.g., by dictating an updated or changed transcoding schedule for the content). Further, it should be appreciated that scheduler feedback 115 and/or transcoder feedback 145 may be communicated to initial priority value generator 120 for updating or changing the information stored in semi-static constraint memory 190, thereby enabling the shorter-term information to be used for adjusting or updating the longer-term information (e.g., stored in semi-static constraint memory 190).

In one embodiment, dynamic constraints 132 may comprise a system-generated input or system-generated constraint (e.g., 136). System-generated input 136 may be generated by one or more components of system 100 in one embodiment. Alternatively, dynamic constraints 132 may comprise a user input or user-input constraint (e.g., 138) in one embodiment. System-generated input 136 and/or user input 138 may comprise a request to reschedule or reprioritize the transcoding of one or more pieces of content, a halt or stall command, a programming/configuration command for controlling at least one component of system 100 (e.g., which is also input to the component or components being controlled), etc. Thus, system-generated input 136 and/or user input 138 may be used by secondary priority value generator 130 to generate a secondary priority value (e.g., 135) which reflects or accommodates the system-generated input (e.g., 136) and/or user input (e.g., 138) in one embodiment.

Accordingly, the demand for transcoding of a given piece of content (e.g., identified by content information 152) may be assessed using knowledge in the form of a dynamic constraint (e.g., 132). Further, where secondary priority value generator 130 generates secondary priority value 135 based upon a dynamic constraint (e.g., 132) and an initial priority value (e.g., 125), the demand for transcoding a given piece of content may be assessed using both shorter-term knowledge (e.g., associated with dynamic constraint 132) and longer-term knowledge (e.g., associated with a semi-static constraint accessed from semi-static constraint memory 190). Thus, content (e.g., 154) may be scheduled for transcoding (e.g., by accessing initial priority value 125 and/or secondary priority value 135 associated with the content) with respect to other pieces of content to reduce resource load on system 100, reduce transcoding cost associated with system 100, improve quality of service associated with system 100, or some combination thereof.

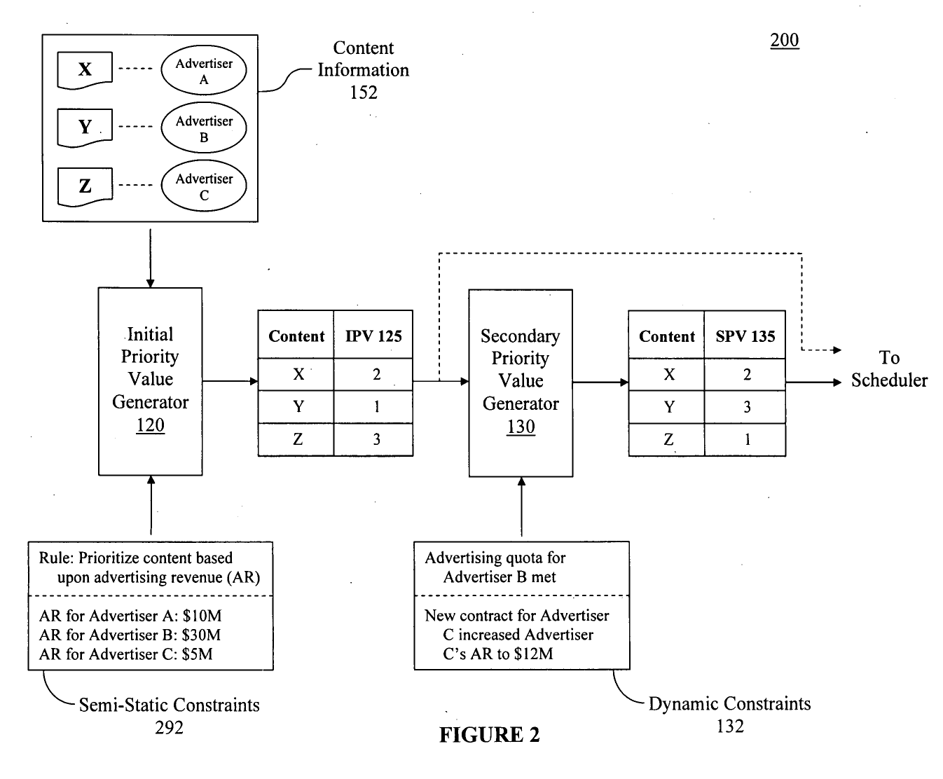

FIG. 2 shows exemplary data flow diagram 200 of priority value generation for use in scheduling of content transcoding in accordance with one embodiment of the present invention. As shown in FIG. 2, initial priority value generator 120 is operable to generate respective initial priority values (e.g., 125) for each piece of content (e.g., 154), labeled in FIG. 2 as X, Y, and Z, based upon content information 152 and semi-static constraints 292 (e.g., accessed from semi-static constraint memory 190).

Content information 152 comprises information about which advertiser (e.g., advertiser A, advertiser B, or advertiser C) is associated with which piece of content (e.g., content X, content Y, or content Z). For example, content X is associated with advertiser A (e.g., because an advertisement from advertiser A is bundled or otherwise part of content X, content X comprises product placement for products associated with advertiser A, etc.).

Additionally, semi-static constraints 292 comprise an exemplary rule which states that content is to be prioritized based upon advertising revenue (e.g., labeled “AR” in FIG. 2). Advertising revenue may comprise revenue of a content distributor or other business entity received from advertisers in one embodiment. Semi-static constraints 292 also comprise information or knowledge about the advertising revenue for each of the advertisers A through C. For example, the advertising revenue for advertiser A is $10M, the advertising revenue for advertiser B is $30M, and the advertising revenue for advertiser C is $5M.

As shown in FIG. 2, both semi-static constraints 292 and content information 152 may be used to prioritize the content. For example, in accordance with the information of semi-static constraints 292, the advertising revenue for advertiser B is the largest of the three advertisers. As such, in one embodiment, the content associated with advertiser B should be transcoded first according to the rule of semi-static constraints 292. Content information 152 may be used to determine that advertiser B is associated with content Y. Therefore, using both semi-static constraints 292 and content information 152, it may be determined that content Y should be assigned an initial priority value of “11” and be transcoded first. Therefore, if initial priority values 125 were used to schedule transcoding of the content (e.g., as indicated by the dashed arrow in FIG. 2), then the content may be transcoded in the following order in one embodiment: content Y, then content X, then content Z

Embodiments also enable scheduling based upon dynamic constraints (e.g., in addition to semi-static constraints). For example, where dynamic constraints 132 indicate that the advertising quota for advertiser B is met (e.g., an amount of advertising determined by the advertising revenue associated with advertiser B has already been provided), then the priority of content (e.g., content Y) associated with advertiser B may be demoted in the transcoding order (e.g., content X and content Z may be transcoded before content Z). Additionally, where dynamic constraints 132 indicate that the advertising revenue associated with advertiser C has been increased (e.g., to $12M based upon a new contract), then the transcoding order may be reorganized based upon the new information. For example, content Z may be promoted in the transcoding order above content X associated with advertiser A whose corresponding advertising revenue is only $5M. Accordingly, it should be appreciated that secondary priority value generator 130 may also utilize information accessible to initial priority value generator 120 (e.g., content information 152, semi-static constraints 292, etc.) when generating second priority values 135. Thus, taking into account both of the dynamic constraints (e.g., 132) depicted in FIG. 2, the following transcoding order may be indicated by secondary priority values 135: content Z, then content X, and then content Y. The secondary priority values (e.g., 135) may thereafter be used to schedule transcoding of the content in one embodiment.

The information collected by secondary priority value generator 130 may be used to update or add to the information in semi-static constraint memory 190 in one embodiment. For example, upon learning that the advertising revenue associated with advertiser C has increased from $5M to $12M, secondary priority value generator 130 may relay this information to initial priority value generator 120 for updating semi-static constraints 292 (e.g., changing $5M to $12M). In other embodiments, another component of system 100 may access the information (e.g., dynamic constraints 132) and perform the update of and/or addition to the information stored within semi-static constraint memory 190.

Turning back to FIG. 1, content source 150 may comprise any system or device capable of generating and/or communicating content. Content source may provide content (e.g., 154) for transcoding in response to content requests in one embodiment. The content requests may comprise a user request for content (e.g., interacting with a user interface to select content for playback and/or storage on a local computer system, etc.). Alternatively, the content request may comprise an “on-demand” request (e.g., in response to a user selecting content to view in exchange for payment). The request may also comprise a request from a content distributor or other business entity who collects and/or bundles content for delivery via one or more channels.

Once transcoded, the content (e.g., 155) may be stored in content memory 160. It should be appreciated that content memory 160 may comprise fast memory for storing commonly-requested files and/or slower memory for storing rarely-requested files. In this manner, content memory 160 may form a cache for storing the more commonly-requested files, thereby reducing the need to re-transcode the same content in response to future requests for the content. Alternatively, transcoded content 155 may be communicated from transcoder 140 to media network 180 and/or to requester 170 without storage in content memory 160, thereby effectively omitting content storage 160 in one embodiment.

In one embodiment, scheduler 110 and/or transcoder 140 may comprise a multi-noded transcoding queue where each piece of content to be transcoded (e.g., 154) may be assigned to one or more nodes of the queue. For example, when the queue is to be reorganized (e.g., in response to a change in semi-static constraints 292, receipt of a dynamic constraint 132, etc.), content may be reprioritized by adding one or more nodes (e.g., to which a piece of content may then be assigned), reassigning content to one or more different nodes, etc.

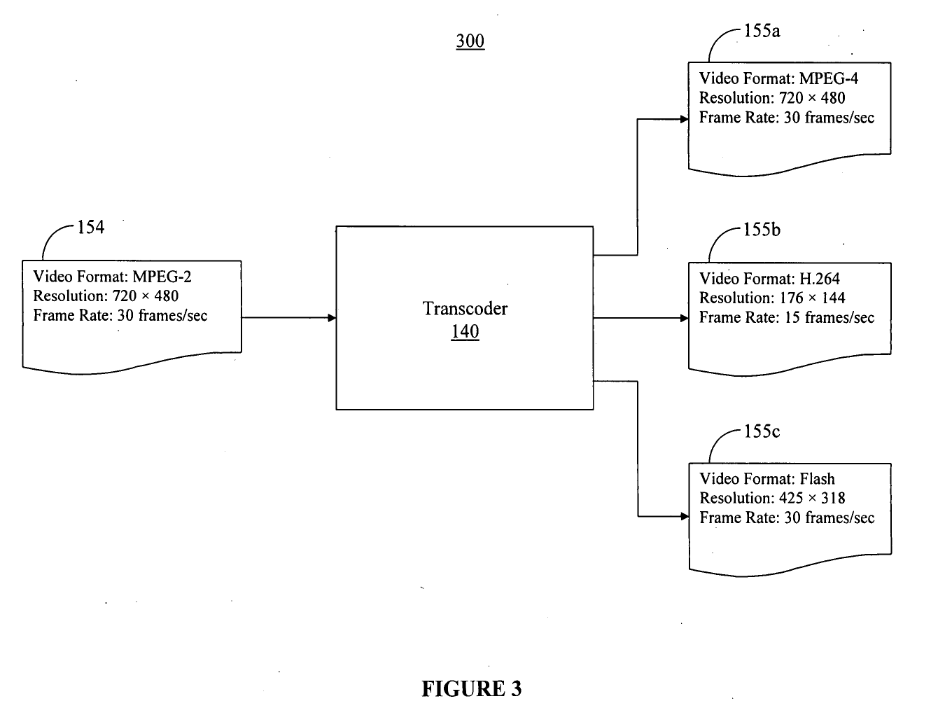

Additionally, transcoder 140 may comprise any transcoder capable of transcoding content into one or more different forms. For example, FIG. 3 shows block diagram 300 of the transcoding of content into multiple forms in accordance with one embodiment of the present invention. As shown in FIG. 3, content 154 is accessed by transcoder 140 and transcoded into content 155a through content 155c. It should be appreciated that content may be transcoded into a larger or smaller number of forms in other embodiments. Further, it should be appreciated that each form of the content depicted in FIG. 3 are merely exemplary, and thus, the content (e.g., 154) and/or any transcoding of the content (e.g., 155a, 155b, 155c, etc.) may comprise different characteristics (e.g., format, resolution, frame rate, etc.) in other embodiments.

As shown in FIG. 3, content 154 comprises a video format of MPEG-2, a resolution of 720 by 480 pixels, and a frame rate of 30 frames per second. Transcoded content 155a comprises a format of MPEG-4, a resolution of 720 by 480 pixels, and a frame rate of 30 frames per second. Transcoded content 155b comprises a format of H.264, a resolution of 176 by 144 pixels, and a frame rate of 15 frames per second. Additionally, transcoded content 155c comprises a format of Flash, a resolution of 425 by 318 pixels, and a frame rate of 30 frames per second.

Turning back to FIG. 1, media network 180 may comprise any network, system, device, etc. capable of communicating transcoded content to a content requester (e.g., 170). Media network 180 may comprise, for example, a PSTN network, mobile telephone network, the internet, local area network, etc. Additionally, content requester 170 may comprise a human, human-controlled device or system (e.g., portable computer system, non-portable computer system, etc.), automated system, etc.

Although FIG. 1 depicts specific components of system 100, it should be appreciated that system 100 may comprise a larger or smaller number of components in other embodiments. For example, one or more components of system 100 (initial priority value generator 120, secondary priority value generator 130, etc.) may be divided into subcomponents. Alternatively, one or more components of system 100 may be combined in other embodiments.

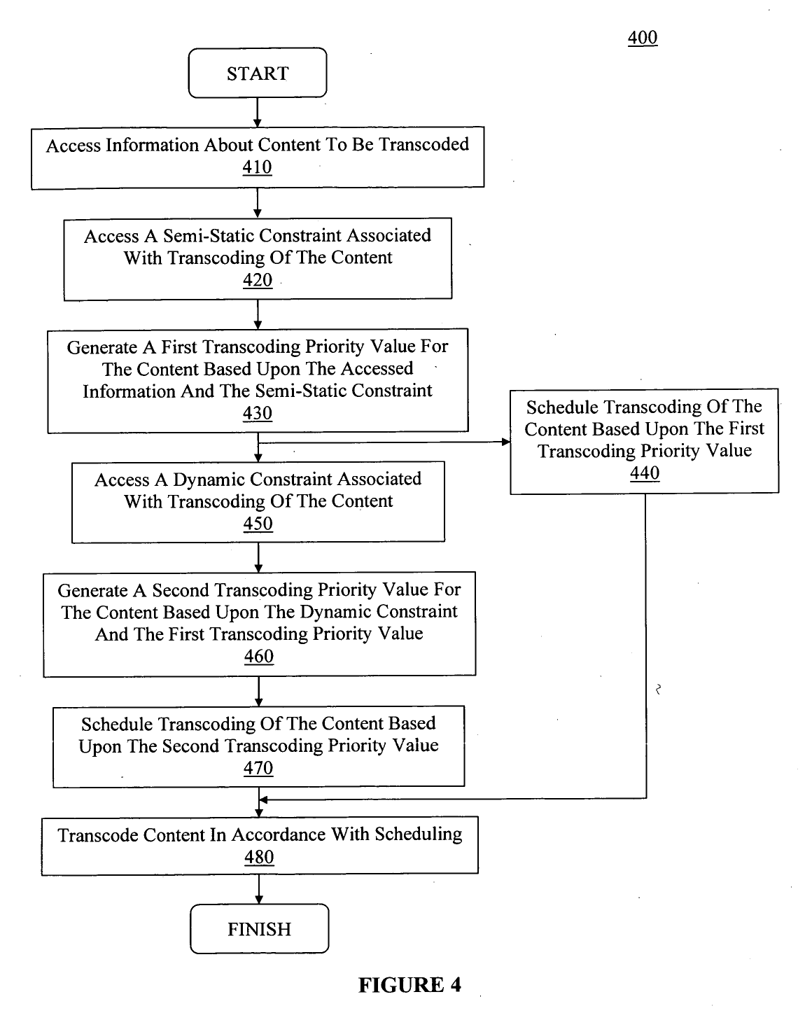

FIG. 4 shows exemplary process 400 for scheduling content transcoding in accordance with one embodiment of the present invention. As shown in FIG. 4, step 410 involves accessing information about content (e.g., 154) to be transcoded. The content may comprise images, video, audio, etc. The information (e.g., 152) about the content may be accessed from a content source (e.g., 150) in one embodiment. Additionally, the content information (e.g., 152) may comprise a file size, a playback duration, a file identifier (e.g., file name, file number, etc.), information about the content prior to transcoding (e.g., a video or data format, a resolution, a frame rate, etc. of content prior to transcoding 154), information about the content after transcoding (e.g., a video or data format, a resolution, a frame rate, etc. of content after transcoding 156), some combination thereof, etc.

Step 420 involves accessing a semi-static constraint associated with transcoding of the content. The semi-static constraint may comprise information, knowledge, rules, etc. which change relatively infrequently and/or with a relatively small magnitude in one embodiment. For example, as discussed above with respect to FIG. 1, the semi-static constraint may comprise a business relationship constraint, a product marketing constraint, a consumption pattern constraint, a system performance constraint, some combination thereof, etc. Additionally, the semi-static constraint (e.g., 292) may be accessed from a semi-static constraint memory (e.g., 190) in one embodiment.

As shown in FIG. 4, step 430 involves generating a first transcoding priority value for the content based upon the accessed information (e.g., accessed in step 410) and the semi-static constraint (e.g., accessed in step 420). For example, where the semi-static constraint comprises a rule associated with prioritization or scheduling of the content for transcoding, the content information (e.g., 152) and/or information from the semi-static constraint may be used to generate the first transcoding priority value for prioritizing the transcoding of the content with respect to other content (e.g., as discussed above with respect to FIGS. 1 and 2). Additionally, the first transcoding priority value (e.g., 125) may be generated by an initial priority value generator (e.g., 120) in one embodiment.

Step 440 involves scheduling transcoding of the content based upon the first transcoding priority value. In this manner, scheduling of the content transcoding may be performed based upon longer-term knowledge (e.g., the semi-static constraint accessed in step 420) in one embodiment, thereby enabling the demand for transcoding of the content to be better assessed (e.g., based upon longer-term knowledge) to reduce resource load on the transcoding system (e.g., 100), reduce transcoding cost associated with the transcoding system (e.g., 100), improve quality of service associated with the transcoding system (e.g., 100), or some combination thereof. Additionally, in one embodiment, the scheduling may be performed by a scheduler (e.g., 110) coupled to an initial priority value generator (e.g., 120) which generates the first transcoding priority value in step 430. Thereafter, in step 480, the content may be transcoded in accordance with the scheduling (e.g., performed in step 440). Transcoding may be performed by a content transcoder (e.g., 140) coupled to the scheduler (e.g., 110) performing the scheduling in step 440 in one embodiment.

Alternatively, a dynamic constraint associated with transcoding of the content may be accessed in step 450. The dynamic constraint (e.g., 132) may comprise information, knowledge, rules, etc. which change more frequently and/or with a larger magnitude than semi-static constraints (e.g., accessed in step 420). For example, as discussed above with respect to FIG. 1, the dynamic constraint (e.g., 132) may comprise a business relationship constraint, a product marketing constraint, a consumption pattern constraint, a system performance constraint, system error (e.g., 115, 135, 138, etc.), system exception (e.g., 115, 135, 138, etc.), another system-generated constraint (e.g., 115, 135, 138, etc.), a user-input constraint (e.g., 138), some combination thereof, etc. Additionally, the dynamic constraint (e.g., 132) may be accessed from an initial priority value generator (e.g., 120) in one embodiment.

As shown in FIG. 4, step 460 involves generating a second transcoding priority value for the content based upon the dynamic constraint (e.g., accessed in step 450) and the first transcoding priority value (e.g., generated in step 430). In one embodiment, the first transcoding priority value may be adjusted based upon the dynamic constraint to generate the second transcoding priority value, thereby enabling the transcoding of the content to be prioritized with respect to other content (e.g., as discussed above with respect to FIGS. 1 and 2). Additionally, the second transcoding priority value (e.g., 135) may be generated by a secondary priority value generator (e.g., 130) in one embodiment.

Step 470 involves scheduling transcoding of the content based upon the second transcoding priority value. In this manner, scheduling of the content transcoding may be performed based upon shorter-term knowledge (e.g., the dynamic constraint accessed in step 450) in one embodiment, thereby enabling the demand for transcoding of the content to be better assessed (e.g., based upon longer-term knowledge and/or shorter-term knowledge) to reduce resource load on the transcoding system (e.g., 100), reduce transcoding cost associated with the transcoding system (e.g., 100), improve quality of service associated with the transcoding system (e.g., 100), or some combination thereof. Additionally, in one embodiment, the scheduling may be performed by a scheduler (e.g., 110) coupled to an initial priority value generator (e.g., 120) which generates the first transcoding priority value in step 430. Thereafter, in step 480, the content may be transcoded in accordance with the scheduling (e.g., performed in step 440). Transcoding may be performed by a content transcoder (e.g., 140) coupled to the scheduler (e.g., 110) performing the scheduling in step 440 in one embodiment.

As shown in FIG. 4, step 480 involves transcoding the content in accordance with the scheduling (e.g., performed in step 470). Transcoding may be performed by a content transcoder (e.g., 140) coupled to the scheduler (e.g., 110) performing the scheduling in step 470 in one embodiment.

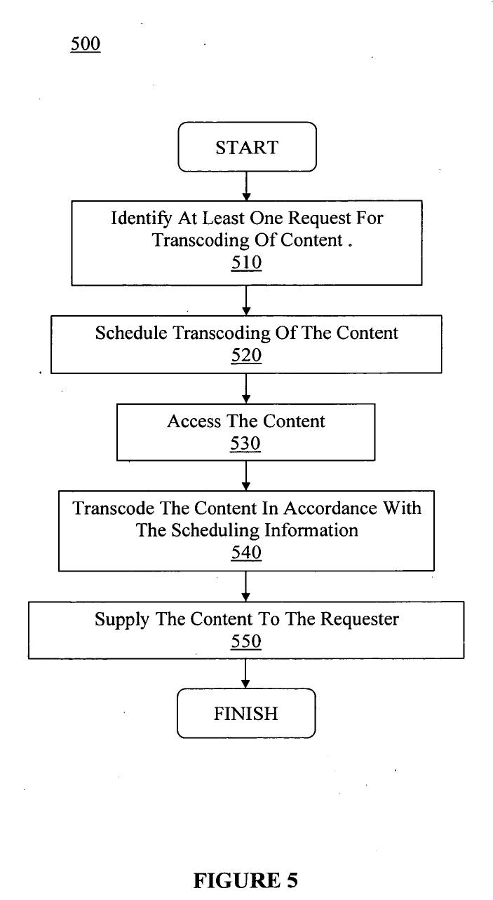

FIG. 5 shows exemplary process 500 for delivering transcoded content to a content requester in accordance with one embodiment of the present invention. As shown in FIG. 5, step 510 involves identifying at least one request for transcoding of content (e.g., 154). The request may be from a content requester (e.g., 170) in one embodiment, where the content requester may comprise a human, human-controlled device or system (e.g., portable computer system, non-portable computer system, etc.), automated system, etc. Additionally, the request may be accessed by a transcoding system (e.g., 100) in one embodiment.

Step 520 involves scheduling transcoding of the content (e.g., 154). The scheduling may be performed based upon at least one semi-static constraint (e.g., as discussed above with respect to step 440 of FIG. 4) and/or using at least one dynamic constraint (e.g., as discussed above with respect to step 470 of FIG. 4). The scheduling may be performed by a scheduler (e.g., 110 of FIG. 1) which receives transcoding priority values generated using semi-static constraints (e.g., by initial priority value generator 120) and/or generated using dynamic constraints (e.g., by secondary priority value generator 130).

As shown in FIG. 5, step 530 involves accessing the content (e.g., 154). The content (e.g., 154) may be accessed from a content source (e.g., 150) in one embodiment. Additionally, the content (e.g., 154) may be accessed by a transcoder (e.g., 140) in one embodiment.

Step 540 involves transcoding the content (e.g., 154) in accordance with the scheduling information (e.g., generated in step 520). The transcoding may be performed by a transcoder (e.g., 140) which accessed content in a first form (e.g., content 154) and outputs content in a second form (e.g., content 155). In one embodiment, step 540 may be performed analogously to step 480 of FIG. 4.

As shown in FIG. 5, step 550 involves supplying the content to the requester (e.g., 170). The content may be supplied using a media network (e.g., 180) in one embodiment. Additionally, in one embodiment, the content (e.g., 155) may be accessed from a content memory (e.g., 160) prior to supplying the content to the content requester. Alternatively, the content (e.g., 155) may be supplied to an entity, person, system, etc. other than the requester (e.g., 170) in one embodiment, where the content (e.g., 155) may be supplied to the other entity, person, system, etc. in lieu of, in parallel with, or via the content requester (e.g., 170).

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A method of scheduling content transcoding, said method comprising:
accessing information about said content to be transcoded;
accessing a semi-static constraint associated with transcoding of said content; and
generating a first transcoding priority value for said content based upon said semi-static constraint and said information, wherein said first transcoding priority value is for use in scheduling transcoding of said content with respect to transcoding of other content.

2. The method of claim 1, wherein said content is selected from a group consisting of: images; video; and audio.

3. The method of claim 1, wherein said information about said content is selected from a group consisting of: a file size; a playback duration; a file identifier; information about said content prior to said transcoding; and
information about said content after said transcoding.

4. The method of claim 1, wherein said semi-static constraint is selected from a group consisting of: a business relationship constraint; a product marketing constraint; a consumption pattern constraint; and a system performance constraint.

5. The method of claim 1 further comprising:
scheduling said transcoding of said content based upon said first transcoding priority value.

6. The method of claim 1 further comprising:
accessing a dynamic constraint associated with transcoding of said content; and
generating a second transcoding priority value for said content based upon said first transcoding priority value and said dynamic constraint, wherein said second transcoding priority value is for use in scheduling transcoding of said content with respect to transcoding of said other content.

7. The method of claim 6, wherein said dynamic constraint is selected from a group consisting of: a business relationship constraint; a product marketing constraint; a consumption pattern constraint; a system performance constraint; a system error; a system exception; another system-generated constraint; and a user-input constraint.

8. The method of claim 6 further comprising:
scheduling said transcoding of said content based upon said second transcoding priority value.

9. A system for scheduling content transcoding, said system comprising:
a memory for storing a semi-static constraint associated with transcoding of content; and
a first component coupled to said memory and for accessing information about said content to be transcoded, said first component further for generating a first transcoding priority value for said content based upon said semi-static constraint and said information, wherein said first transcoding priority value is for use in scheduling transcoding of said content with respect to transcoding of other content.

10. The system of claim 9, wherein said content is selected from a group consisting of: images; video; and audio.

11. The system of claim 9, wherein said information about said content is selected from a group consisting of: a file size; a playback duration; a file identifier; information about said content prior to said transcoding; and
information about said content after said transcoding.

12. The system of claim 9, wherein said semi-static constraint is selected from a group consisting of: a business relationship constraint; a product marketing constraint; a consumption pattern constraint; and a system performance constraint.

13. The system of claim 9 further comprising:
a scheduler for scheduling said transcoding of said content based upon said first transcoding priority value.

14. The system of claim 9 further comprising:
a second component coupled to said first component and for accessing a dynamic constraint associated with transcoding of said content, said second component further for generating a second transcoding priority value for said content based upon said first transcoding priority value and said dynamic constraint, and wherein said second transcoding priority value is for use in scheduling transcoding of said content with respect to transcoding of said other content.

15. The system of claim 14, wherein said dynamic constraint is selected from a group consisting of: a business relationship constraint; a product marketing constraint; a consumption pattern constraint; a system performance constraint; a system error; a system exception; another system-generated constraint; and a user-input constraint.

16. The system of claim 14 further comprising:
a scheduler for scheduling said transcoding of said content based upon said second transcoding priority value.

17. A system for transcoding content, said system comprising:
a memory for storing a semi-static constraint associated with transcoding of content;
a first component coupled to said memory and for accessing information about said content to be transcoded, said first component further for generating a first transcoding priority value for said content based upon said semi-static constraint and said information;
a scheduler coupled to said first component and for scheduling said transcoding of said content based upon said first transcoding priority value; and
a transcoder coupled to said scheduler and for accessing and transcoding said content in accordance with said scheduling.

18. The system of claim 17, wherein said content is selected from a group consisting of: images; video; and audio.

19. The system of claim 17, wherein said information about said content is selected from a group consisting of: a file size; a playback duration; a file identifier; information about said content prior to said transcoding; and information about said content after said transcoding.

20. The system of claim 17, wherein said semi-static constraint is selected from a group consisting of: a business relationship constraint; a product marketing constraint; a consumption pattern constraint; and a system performance constraint.

21. The system of claim 17, wherein Further comprising:
a second component coupled to said first component and for accessing a dynamic constraint associated with transcoding of said content, said second component further for generating a second transcoding priority value for said content based upon said first transcoding priority value and said dynamic constraint, and wherein said second transcoding priority value is for use in scheduling said transcoding of said content with respect to said transcoding of said other content.

22. The system of claim 21, wherein said dynamic constraint is selected from a group consisting of: a business relationship constraint; a product marketing constraint; a consumption pattern constraint; a system performance constraint; a system error; a system exception; another system-generated constraint; and a user-input constraint.

23. The system of claim 21, wherein said scheduler is further operable to schedule said transcoding of said content based upon said second transcoding priority value.
